(19) United States
(12) Patent Application Publication
(10) Pub. No.: US 2014/0345708 A1
(43) Pub. Date: Nov. 27, 2014

(54) DISPENSER NITROGEN PURGE

(71) Applicant: CLEAN ENERGY FUELS CORP., NEWPORT BEACH, CA (US)

(72) Inventors: Kenny Oldham, Coalville, UT (US); Devin Martin, Evanston, WY (US)

(21) Appl. No.: 13/902,601

(22) Filed: May 24, 2013

(51) Int. Cl. F17C 13/10

(52) U.S. Cl. CPC F17C 13/10
USPC 137/341

(57) ABSTRACT

A dispenser nitrogen purge and heater system for a liquid natural gas (LNG) fueling dispenser, comprising a nitrogen purge enclosure; a nitrogen container containing nitrogen; a nitrogen feed line for feeding nitrogen from the nitrogen container to the nitrogen purge enclosure; a heater for heating an interior space within the enclosure; and a fan assembly for circulating the nitrogen within the interior space

### FIELD OF THE INVENTION

The invention broadly relates to a dispenser nitrogen purge and heater system for a liquid natural gas (LNG) fueling dispenser.

### BACKGROUND OF THE INVENTION

In certain cold and humid regions such as Canada and parts of the United States, LNG fuel dispensers can experience ice and/or frost build-up issues. The ice tends to build up on the process piping of the fuel dispenser in a fashion that limits maintenance access and dispenser operation. As a further complication, the ice cannot be melted without potentially irreparably damaging the dispenser electronics disposed below the melting ice.

There currently exists several unsatisfactory solutions to this ice build-up on LNG fuel dispensers located in cold and humid regions. One such solution involves ceasing use of the dispenser to allow it to thaw out. However, this solution is extremely inefficient and can take an indefinite amount of time. Another solution involves spraying water continuously on the piping until the ice was melted. However, this solution can damage the dispenser electronics located below the piping.

### SUMMARY OF THE INVENTION

Certain embodiments of the present invention are directed toward a dispenser nitrogen purge and heater system for a liquid natural gas (LNG) fueling dispenser. The system addresses the above-identified issues associated with ice build-up on LNG fuel dispensers, particularly in cold and humid regions. Specifically, the system prevents ice from forming on the process piping in the dispenser enclosure, thereby permitting maintenance access and allowing full dispenser operation.

The nitrogen purge and heater system embodiments described herein are directed toward providing preventative maintenance for LNG fueling dispensers. By way of example, the system: (i) protects against water damage to electronics, (ii) allows service access to dispenser components, and (iii) eliminates frost from generating on the exterior of the process piping purge enclosure.

One embodiment of the invention is directed toward a dispenser nitrogen purge and heater system for a liquid natural gas (LNG) fueling dispenser, comprising a nitrogen purge enclosure; a nitrogen container containing nitrogen; a nitrogen feed line for feeding nitrogen from the nitrogen container to the nitrogen purge enclosure; a heater for heating an interior space within the enclosure; and a fan assembly for circulating the nitrogen within the interior space. The nitrogen purge enclosure can form a portion of the LNG dispenser.

In operation, the heater maintains the interior space of the nitrogen purge enclosure at a temperature above freezing. In some embodiments, the heater is controlled to keep the temperature of the interior space within a desired temperature range. The fan assembly may comprise a fan attached to the nitrogen purge enclosure by way of a magnetic coupler. In certain embodiments, nitrogen is introduced through a nitrogen inlet of the enclosure at a rate of approximately 1 cubic feet per minute to ensure a positive purge pressure. In further embodiments, nitrogen is introduced into the enclosure at a rate of between 0.75 and 1.25 cubic feet per minute to ensure a positive purge pressure. The nitrogen purge and heater system inhibits ice and frost from generating in the interior space during operation of the LNG dispenser. In addition, the nitrogen purge and heater system eliminates frost from generating on an exterior of the nitrogen purge enclosure, and prevents frost from generating on process piping within the enclosure. The process piping can include piping insulation in the form of pipe wrap that is secured by custom fitting and VELCRO.

In some embodiments, the nitrogen purge enclosure is formed of sheet metal that is sealed to minimize the nitrogen purge flow rate required to maintain a substantially moisture-free environment in the interior space. A top panel of the enclosure can be removable to allow maintenance access. The panel can be made of a suitable material such as poly(methyl methacrylate) (PMMA). In certain embodiments, the nitrogen purge enclosure is completely sealed such that it is substantially air tight. In further embodiments, the enclosure is sealed to an extent needed to minimize a nitrogen leak rate of the enclosure to allow a relatively low nitrogen container capacity.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1 is a diagram illustrating a dispenser nitrogen purge and heater system in accordance with an embodiment of the invention.

FIG. 2 is a front view of a LNG dispenser having ice build-up on the front face of the dispenser.

FIG. 3 is a side view of a LNG dispenser having ice build-up on a side face of the dispenser.

FIG. 4 is a perspective view showing ice build-up on process piping within the dispenser.

FIG. 5 is a perspective view showing ice build-up on dispenser valves of the dispenser.

FIG. 6 is a perspective view of the outside of the dispenser, wherein an upper portion of the dispenser cabinet forms the nitrogen purge enclosure of FIG. 1. In other embodiments, the nitrogen purge enclosure can form a different portion of the dispenser cabinet such as a lower portion of the cabinet, or any other suitable area within the cabinet.

FIG. 7 is a perspective view showing the inside of the nitrogen purge enclosure of FIG. 1, wherein the enclosure panels have been removed.

FIG. 8 is a perspective view showing the fan and heater within the nitrogen purge enclosure of FIG. 1, wherein the enclosure panels have been removed.

### DETAILED DESCRIPTION

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s).

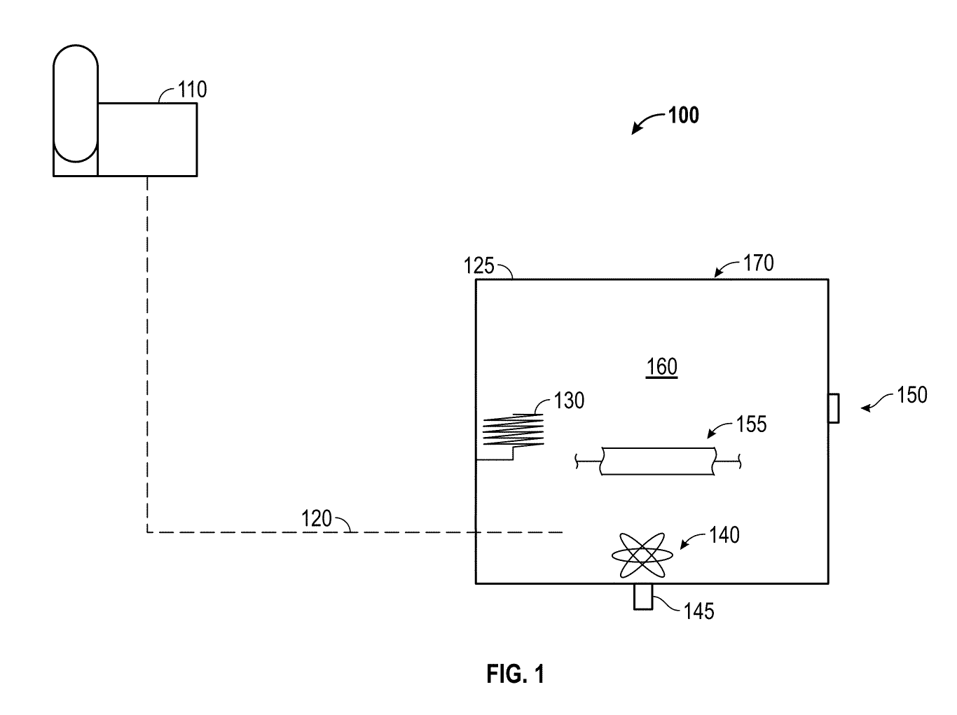

FIG. 1 is a diagram illustrating a dispenser nitrogen purge and heater system 100 for an LNG dispenser in accordance with an embodiment of the invention. The system 100 comprises nitrogen container 110, nitrogen feed line 120 for feeding nitrogen to a nitrogen purge enclosure 125, heater 130, and fan assembly including fan 140 and fan motor 145. The nitrogen purge enclosure 125 provides a large interior space 160 containing heater 130, fan 140, and process piping 155 of the LNG dispenser. Additionally, system 100 can include thermostat 150 or other means for regulating the temperature inside of the enclosure 125.

In operation, dispenser nitrogen purge and heater system 100 prevents ice from forming on the process piping 155 within nitrogen purge enclosure 125, thus permitting maintenance access and allowing full dispenser operation. Without using a nitrogen purge, ice build-up can occur on process piping 155 when the LNG dispenser is in use. The build-up can be particularly severe in cold and humid climate regions. However, this problem is resolved by adding the nitrogen purge and heating system 100 described herein. In some embodiments, the nitrogen purge enclosure 125 is located at a top portion of the LNG dispenser. By way of example, the LNG dispenser can comprise an AK-1000 LNG Dispenser manufactured by NorthStar, Inc. The top portion of the dispenser forms the nitrogen purge enclosure 125.

With continued reference to FIG. 1, the heater 130 has an electrical classification that is suitable for its use. Heater 130 is employed to maintain the nitrogen purge enclosure 125 at a temperature above freezing. The heater 130 can be controlled using thermostat 150 to keep the temperature within enclosure 125 within a desired temperature range. In other embodiments, a temperature probe can be employed for regulating the heater 130. The temperature probe may be governed by a programmable logic controller (PLC) of the dispenser, thereby allowing remote monitoring of the purge system, and providing advanced notice of failure issues such as fan stoppage, heater failure, nitrogen purge leaks, etc. The fan 140 circulates both the heat and the nitrogen throughout the interior space 160 of the nitrogen purge enclosure 125. By way of example, the fan 140 can comprise a conventional fan that is 8-inches in diameter. In some embodiments, the fan assembly including fan 140 and fan motor 145 is attached to the nitrogen purge enclosure 125 by way of one or more magnetic couplers, thereby obviating the need to add an additional access hole to allow the fan 140 to operate in the enclosure 125.

Nitrogen is provided to the nitrogen purge enclosure 125 by way of the nitrogen container 110. In some embodiments, the nitrogen container 110 comprises an on-site nitrogen generator. In other embodiments, the nitrogen container 110 comprises a nitrogen storage bottle. In certain embodiments, nitrogen is introduced into the enclosure 125 at a rate of 1 cubic feet per minute to ensure a positive purge pressure. In further embodiments, nitrogen is introduced into the enclosure 125 at a rate of between 0.75 and 1.25 cubic feet per minute to ensure a positive purge pressure. During operation of the LNG dispenser, the nitrogen purge inhibits ice and frost from generating. Without the nitrogen purge, this ice and frost would have to be melted, which can then drip onto the dispenser electronics located underneath the process piping 155. By inhibiting ice generation, the nitrogen purge protects against water damage to the dispenser electronics. In addition, the nitrogen purge eliminates frost from generating on the exterior of the nitrogen purge enclosure 125.

In some embodiments, the nitrogen purge enclosure 125 is formed of sheet metal that is sealed to minimize the nitrogen purge flow rate required to maintain a substantially moisture-free environment. The top panel 170 of the enclosure can be removable for maintenance access. In certain embodiments, the nitrogen purge enclosure 125 is substantially completely sealed. In further embodiments, the enclosure 125 is not completely sealed, but is sealed to the extent needed to minimize the leak rate to permit a relatively low nitrogen generator capacity. The process piping 155 can include piping insulation 180 such as pipe wrap that is secured by custom fitting and VELCRO. Piping insulation 180 helps keep the heat transfer to the LNG product at a minimum level.

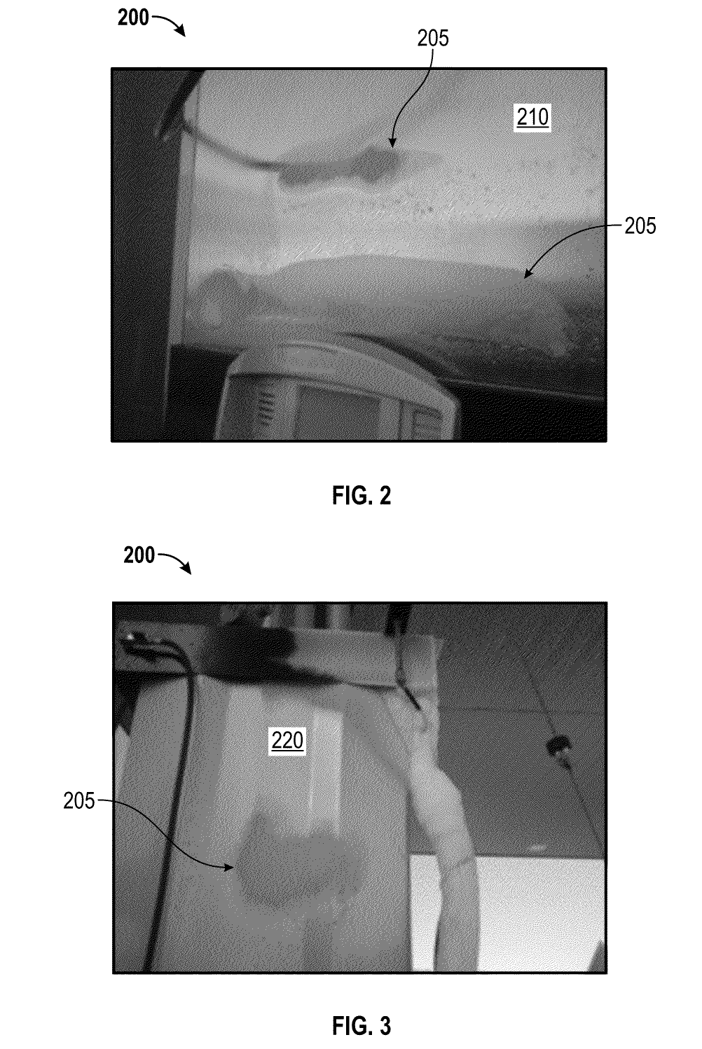

FIG. 2 is a front view of a LNG dispenser 200 having ice build-up 205 on the front face 210 of the dispenser. This ice build-up can be caused by operation of the system in cold and humid environments. According to embodiments of the invention, the LNG dispenser 200 can be formed with, or retrofitted to include, the nitrogen purge and heater system 100 of FIG. 1 in order to prevent the ice build-up shown in FIG. 2.

FIG. 3 is a side view of the LNG dispenser 200 of FIG. 2 showing ice build-up 205 on a side face 220 of the dispenser 200.

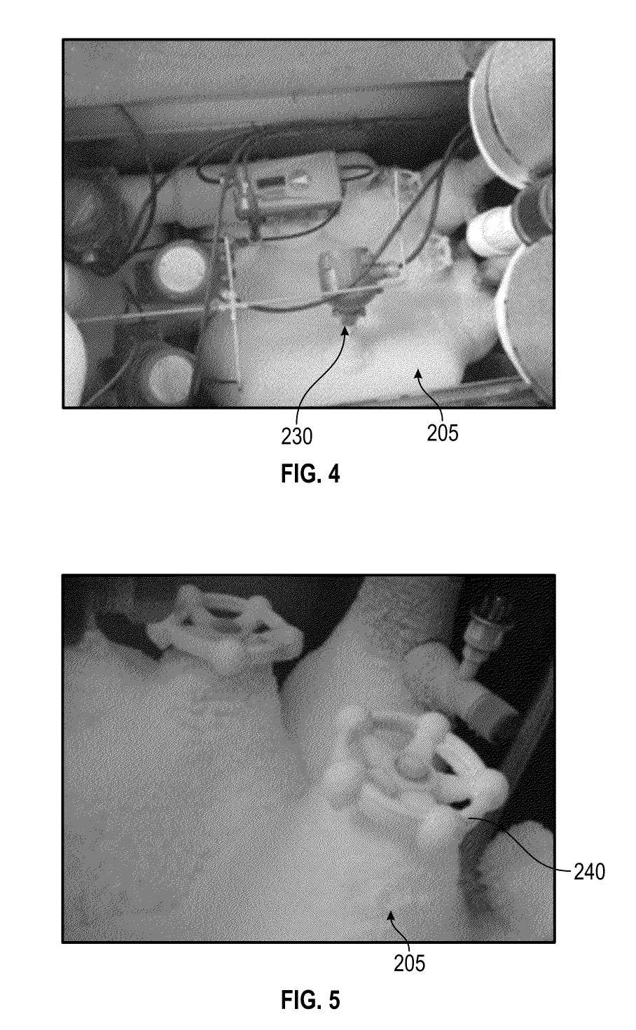

FIG. 4 is a perspective view showing ice build-up 205 on process piping 230 within the LNG dispenser 200 of FIG. 2.

FIG. 5 is a perspective view showing ice build-up on dispenser valves 240 of the LNG dispenser 200 of FIG. 1.

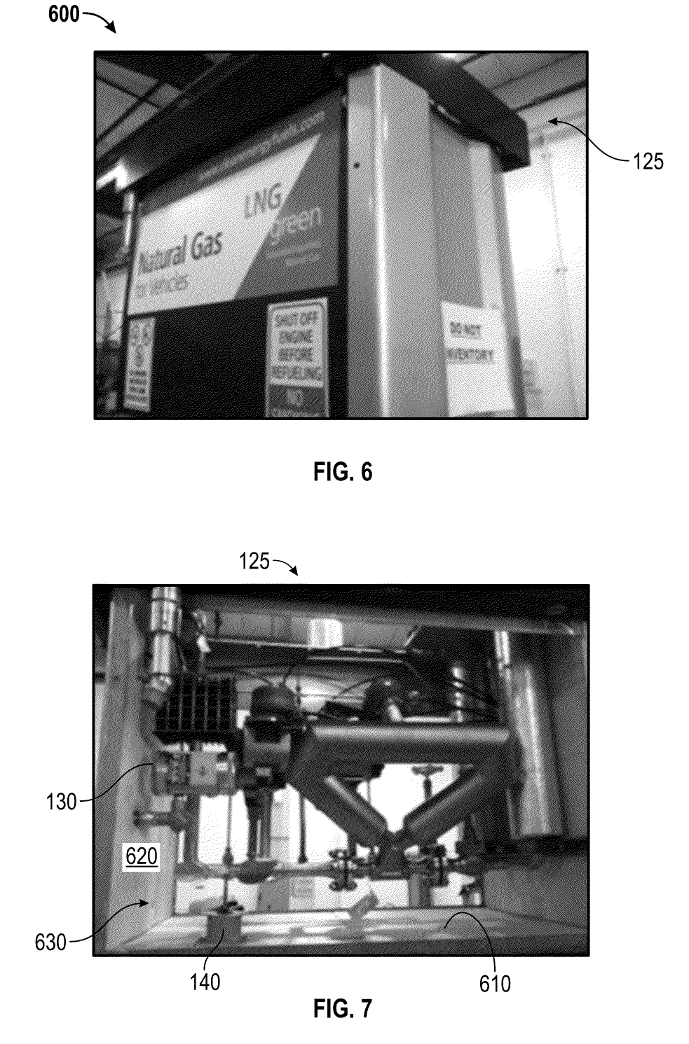

FIG. 6 is a perspective view of the outside of an LNG dispenser 600 having a nitrogen purge enclosure 125 housing the nitrogen purge and heater system 100 illustrated in FIG. 1. In the illustrated embodiment, the LNG dispenser 600 comprises a large cabinet, wherein an upper portion of the dispenser cabinet forms the nitrogen purge enclosure 125. In other embodiments, the nitrogen purge enclosure can form a different portion of the dispenser cabinet such as a lower portion of the cabinet, or any other suitable area within the cabinet. In some configurations, the LNG dispenser 600 is formed with the nitrogen purge and heater system 100 of FIG. 1 in order to prevent the ice build-up shown in FIGS. 2-5. In other embodiments, the LNG dispenser 600 is retrofitted to include the nitrogen purge and heater system 100 of FIG. 1 in order to prevent the ice build-up shown in FIGS. 2-5.

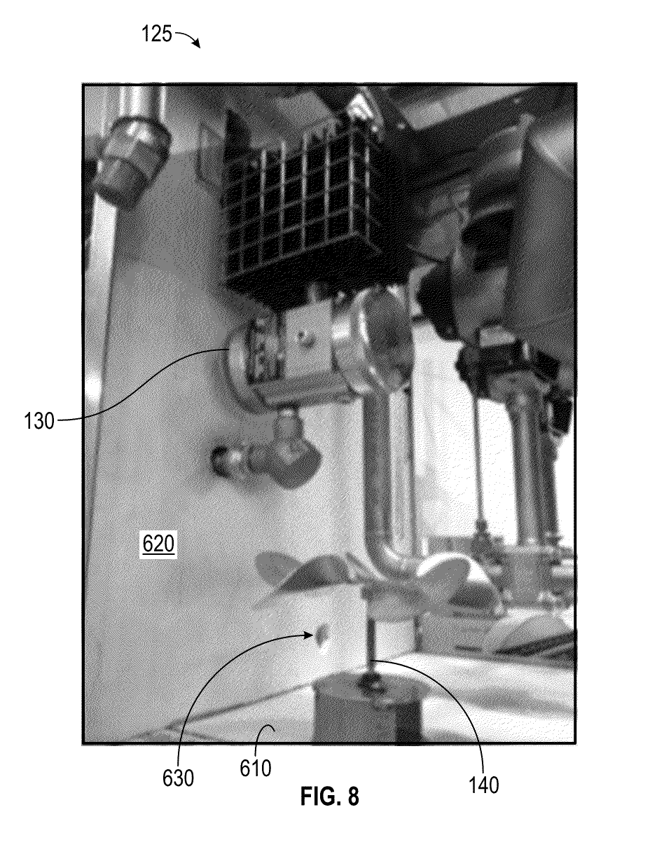

FIGS. 7 and 8 are perspective view showing the inside 160 of the nitrogen purge enclosure 125 of FIG. 1, wherein the enclosure panels have been removed. In particular, the fan 140 is disposed at the bottom panel 610 of the enclosure 125, and the heater 130 is disposed near the left panel 620 of the enclosure 125. The inlet 630 of the nitrogen feed line 120 is formed in a lower portion of the left panel 620 adjacent to the bottom panel 610.

One skilled in the art will appreciate that the present invention can be practiced by other than the various embodiments and preferred embodiments, which are presented in this description for purposes of illustration and not of limitation, and the present invention is limited only by the claims that follow. It is noted that equivalents for the particular embodiments discussed in this description may practice the invention as well.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

1. A dispenser nitrogen purge and heater system for a liquid natural gas (LNG) fueling dispenser, comprising:
a nitrogen purge enclosure;
a nitrogen container containing nitrogen;
a nitrogen feed line for feeding nitrogen from the nitrogen container to the nitrogen purge enclosure;
a heater for heating an interior space within the enclosure; and
a fan assembly for circulating the nitrogen within the interior space.

2. The system of claim 1, wherein the heater maintains the interior space of the nitrogen purge enclosure at a temperature above freezing.

3. The system of claim 1, wherein the heater is controlled to keep the temperature of the interior space within a desired temperature range.

4. The system of claim 1, wherein the nitrogen purge enclosure forms a portion of the LNG dispenser.

5. The system of claim 1, wherein the fan assembly comprises a fan attached to the nitrogen purge enclosure by way of a magnetic coupler.

6. The system of claim 1, wherein nitrogen is introduced through a nitrogen inlet of the enclosure at a rate of approximately 1 cubic feet per minute to ensure a positive purge pressure.

7. The system of claim 1, wherein nitrogen is introduced into the enclosure at a rate of between 0.75 and 1.25 cubic feet per minute to ensure a positive purge pressure.

8. The system of claim 1, wherein the nitrogen purge and heater system inhibits ice and frost from generating in the interior space during operation of the LNG dispenser.

9. The system of claim 1, wherein the nitrogen purge and heater system eliminates frost from generating on an exterior of the nitrogen purge enclosure.

10. The system of claim 1, wherein the nitrogen purge enclosure is formed of sheet metal that is sealed to minimize the nitrogen purge flow rate required to maintain a substantially moisture-free environment in the interior space.

11. The system of claim 10, wherein a top panel of the enclosure is removable to allow maintenance access.

12. The system of claim 1, wherein the nitrogen purge enclosure is completely sealed such that it is substantially air tight.

13. The system of claim 1, wherein the enclosure is sealed to an extent needed to minimize a nitrogen leak rate of the enclosure to allow a relatively low nitrogen container capacity.

14. The system of claim 1, wherein the nitrogen purge and heater system prevents frost from generating on process piping within the enclosure.

15. The system of claim 14, wherein the process piping includes piping insulation in the form of pipe wrap that is secured by custom fitting and VELCRO.

16. The system of claim 1, wherein the nitrogen container comprises an on-site nitrogen generator.

17. The system of claim 1, wherein the nitrogen container comprises a nitrogen storage bottle.

18. A dispenser nitrogen purge and heater system for a liquid natural gas (LNG) fueling dispenser, comprising:
a nitrogen purge enclosure;
a nitrogen container containing nitrogen;
a nitrogen feed line for feeding nitrogen from the nitrogen container to the nitrogen purge enclosure;
a heater for maintaining the interior space of the nitrogen purge enclosure at a temperature above freezing, wherein the heater is controlled to keep the temperature of the interior space within a desired temperature range; and
a fan assembly for circulating the nitrogen within the interior space;
wherein the nitrogen purge enclosure forms a portion of the LNG dispenser.

19. The system of claim 18, wherein nitrogen is introduced through a nitrogen inlet of the enclosure at a rate of approximately 1 cubic feet per minute to ensure a positive purge pressure.

20. The system of claim 18, wherein nitrogen is introduced into the enclosure at a rate of between 0.75 and 1.25 cubic feet per minute to ensure a positive purge pressure.

21. The system of claim 18, wherein the nitrogen purge enclosure is formed of sheet metal that is sealed to minimize the nitrogen purge flow rate required to maintain a substantially moisture-free environment in the interior space.

22. The system of claim 21, wherein a top panel of the enclosure is removable to allow maintenance access.
